(19) United States
(12) Patent Application Publication
(10) Pub. No.: US 2007/0206280 A1
(43) Pub. Date: Sep. 6, 2007

(54) Light source and screen

(75) Inventors: Gregory J. May, Corvallis, OR (US); Andrew K. Juenger, Brush Prairie, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company LP

(21) Appl. No.: 11/368,801

(22) Filed: Mar. 6, 2006

(51) Int. Cl. G03B 21/56

(52) U.S. Cl. 359/443

(57) ABSTRACT

Various embodiments and methods related to a light source and screen are disclosed.

### BACKGROUND

Projection systems project and reflect images off of a screen. Ambient light that is also reflected off the screen may reduce image contrast. Attempts to reduce the reflection of ambient light may reduce brightness of the reflected images.

### BRIEF DESCRIPTION OF THE DRAWINGS

FIG. 1 schematically illustrates an embodiment of a projection system according to one example embodiment.

FIG. 2 illustrates one example of a synchronization timing sequence that may be employed by the projection system of FIG. 1 according to one example embodiment.

FIG. 3 illustrates another example of a synchronization timing sequence that may be employed by the projection system of FIG. 1 according to one example embodiment.

FIG. 5A schematically illustrates another embodiment of the projection system of FIG. 1 according to one example embodiment.

FIG. 5B illustrates another embodiment of the projection system of FIG. 1 according to an example embodiment.

FIG. 5C illustrates another embodiment of the projection system of FIG. 1 according to an example embodiment.

FIG. 5D illustrates another embodiment of the projection system of FIG. 1 according to an example embodiment.

FIG. 6 is an example graph illustrating modification of alternating current performed by a current treatment device of the projection system of FIG. 5D according to an example embodiment.

FIG. 7 schematically illustrates another embodiment of the projection system of FIG. 1 according to an example embodiment.

FIG. 8 is a sectional view schematically illustrating an embodiment of a screen of the projection system of FIG. 7 taken along line 7-7 of FIG. 7 according to an example embodiment.

FIG. 8 is a sectional view of light source modulator of the projection system of FIG. 7 taken along line 8-8 according to an example embodiment.

FIG. 10 is a sectional view of an ambient light source according to an example embodiment.

FIG. 11 is a bottom plan view of another ambient light source of the projection system of FIG. 7 taken along line 10-10 according to an example embodiment.

### DETAILED DESCRIPTION OF THE EXAMPLE EMBODIMENTS

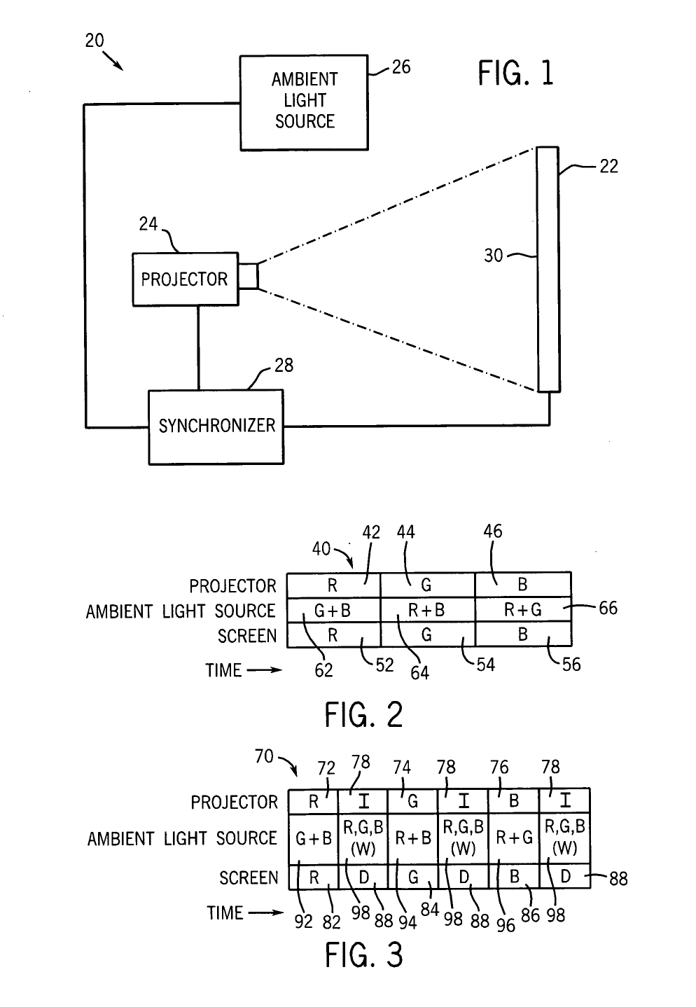

FIG. 1 schematically illustrates projection system 20 configured to display images in the presence of ambient light. Projection system 20 generally includes screen 22, projector 24, ambient light source 26 and synchronizer 28. Screen 22 comprises a structure having a surface 30 configured to rapidly change or flicker between different reflective states in which screen 22 reflects distinct portions of the visible portion of the electromagnetic spectrum while absorbing or scattering corresponding remaining visible portions of the electromagnetic spectrum. For example, in one embodiment, screen 22 may be configured to change between a first screen reflective state in which a red colored light is reflected while green colored light and blue colored light are not reflected (i.e., absorbed), a second screen reflective state in which green colored light is reflected and red and blue light are not reflected and a third screen reflective state in which blue colored light is reflected while red and green colored light are not reflected. In yet other embodiments, screen 22 may be configured to change between different screen reflective states in which other colors or portions of the visible electromagnetic spectrum are selectively reflected. For example, in other embodiments, screen 22 may alternatively be configured to change reflective states in which cyan, magenta and yellow light are reflected.

Screen 22 is further configured to cycle between all of the different reflective states (i.e., (1) red, green and blue or (2) cyan, magenta and yellow) at a frequency greater than a flicker fusion frequency of an observer. In one embodiment, screen 22 is configured to cycle between such states at least 50 times per second or 50 hertz. In one particular embodiment, screen 22 cycles through the different reflective states at a frequency of at least about 72 hertz.

Projector 24 comprises a device configured to project light towards surface 30 of screen 22 such that the incident light is reflected from screen 22 and is viewable by an observer, such as a person or electronics like a web cam or sensor. Projector 24 is further configured to change between different projection states in which different colored light is projected towards screen 22. In particular, projector 24 is configured to change between different projection states in which projector 24 projects different colors of light corresponding to the different colors of light that may be reflected by screen 22 in its different screen reflective states. For example, in one embodiment, projector 24 is configured to change between a first projection state in which red colored light is projected and green and blue colored light are not projected, a second projection state in which green colored light is projected and blue and red light are not projected and a third projection state in which blue colored light is projected while red and green light are not projected. In yet another embodiment, projector 24 may alternatively be configured to change between projection states in which other colors are projected. For example, in another embodiment, projector 24 may alternatively be configured to change between projection states in which cyan, magenta and yellow colored light are projected.

In one embodiment, projector 24 may comprise a digital light processing (DLP) projector. In other embodiments, projector 24 may comprise a 35 millimeter projector, an overhead projector or other devices configured to project images of light upon screen 22. In other embodiments, projector 24 may also be configured to project other wavelengths of electromagnetic radiation such as infrared light or ultraviolet light and the like.

A light source, such as ambient light source 26 comprises a source of ambient light for the environment of projector 24 and screen 22. Ambient light source 26 is configured to rapidly change or flicker between different source states in which different colored light is provided to the environment of screen 22. According to one embodiment, ambient light source 26 is configured to change between different source states such that when screen 22 is reflecting a first colored light, ambient light source 26 is providing another color or colors of light and not providing the color of light beam being reflected by screen 22. In yet another embodiment, ambient light source 26 may be configured to change between the different source states based additionally upon the color or colors of light being projected by projector 24. For example, ambient light source 26 is configured to change between the different source states such that when projector 24 is projecting a first colored light and screen 22 is reflecting a first colored light, ambient light source 26 is providing another color or other colors of light and not providing or blanking the color of light being projected by projector 24.

In one embodiment, ambient light source 26 is configured to change between a first source state in which green colored light is provided and red and blue light are not provided, a second source state in which blue light is provided and red and green light are not provided and a third source state in which red colored light is provided while green and blue light are not provided. In yet another embodiment, ambient light source 26 is configured to change between a first source state in which green and blue colored light are provided and red light is not provided, a second source state in which red and blue light are provided and green colored light is not provided and a third source state in which red and green colored light are provided while blue colored light is not provided. In yet another embodiment, ambient light source 26 is configured to selectively provide other colors of light such as cyan, magenta and yellow light.

Ambient light source 26 is configured to cycle through its different source states at a frequency of at least 50 hertz. In one embodiment, light source 26 is configured to cycle between the different source states at a frequency of at least about 72 hertz. In one particular embodiment, ambient light source 26 may also be configured to change to a source state in which white light is provided.

Examples of ambient light source 26 include solid state emitters configured to emit different colors of light, such as different colored light emitting diodes. In other embodiments, ambient light source 26 may comprise generally continuous light emitters such as continuous incandescent lamps that are additionally provided with a mechanical or electrical filter such that the color of light being projected by projector 24 and being reflected by screen 22 is filtered out at the ambient light source 26. In still other embodiments, ambient light source 26 may comprise a window having a mechanical or electrical filter such that different colors of light are selectively transmitted through the window while other colors of light are selectively filtered. For example, in one embodiment, ambient light source 26 may comprise a window having a filter that changes between a first filter state in which red colored light is filtered, a second filter state in which green colored light is filtered and a third filter state in which blue colored light is filtered with the remaining colors of light being transmitted through the window.

According to one embodiment, ambient light source 26 comprises a single source of ambient light which cycles through different source states at a frequency greater than or equal to a flicker fusion frequency of observers. In another embodiment, ambient light source 26 may comprise multiple sources of ambient light which are synchronized and in phase with one another, wherein the multiple sources cycle through all the colors at a common frequency or multiples of a common frequency greater than or equal to a flicker fusion frequency of an observer. In still another embodiment, ambient light source 26 may comprise multiple sources of ambient light which cycle through all the colors at the same frequency or frequencies that are multiples of one another, but which are out of phase, wherein there is a common point or “notch” in time where the one or more colors are not being emitted from the ambient sources 26. For example if RED light is being reflected from the screen 22, multiple sources of ambient light source 26 may be flickering, may be providing multiple colors of light and may be out of phase as long as RED light is not being provided. For example, in one embodiment, ambient light source 26 may include a first light source flickering at 30 hertz and another ambient light source flickering at 30 hertz but 180 degrees out of phase with the first ambient light source. If coverage is sufficient, it may appear to an observer that the lights are running at 60 hertz in phase on the resulting lit surfaces because there is a 60 Hz component as well as a 30 Hz component, but sources may have smaller intensity notches to potentially be less irritating to observers.

Synchronizer 28 comprises one or more devices configured to synchronize or otherwise appropriately time the changing of screen 22, the ambient light source 26, and projector 24. In one embodiment, synchronizer 28 generates control signals for directing the changing of screen 22, projector 24 and ambient light source 26 such that screen 22 and projector 24 reflect and project the same color of light while ambient light source 26 provides one or more other colors of light.

FIG. 2 schematically illustrates one example of a synchronization timing sequence 40 that may be implemented by synchronizer 28. In the timing sequence 40 shown in FIG. 2, projector 24 changes or modulates between a first projection state 42 in which projector 24 (shown in FIG. 1) projects red light, a second projection state in which projector 24 projects green light and a third projection state 46 in which projector 24 projects blue light. As shown in FIG. 2, screen 22 changes between a first reflective state 52 in which screen 22 reflects red light, a second reflective state 54 in which screen 22 reflects green light and a third reflective state 56 in which screen 22 reflects blue light. Synchronizer 28 is configured such that screen 22 (shown in FIG. 1) is in states 52, 54 and 56 when projector 24 is in projection states 42, 44 and 46, respectively. In one particular embodiment, changing of screen 22 is synchronized with the changing of projector 24.

As further shown by FIG. 2, ambient light source 26 (shown in FIG. 1) changes between a first source state 62 in which source 26 provides green and blue light, a second source state 64 in which source 26 provides red and blue light and a third source state 66 in which ambient light source 26 provides red and green light. Synchronizer 28 is configured such that ambient light source 26 is in states 62, 64 and 66 when projector 24 is in states 42, 44 and 46 and when screen 22 is in states 52, 54 and 56, respectively. In one embodiment, synchronizer 28 is configured such that ambient light source 26 changes between states 62, 64 and 66 in a synchronized manner with respect to the changing of projector 24 and screen 22 between their states. Synchronizer 28 is further configured such that screen 22, projector 24 and ambient light source 26 each cycle through their respective states at frequency greater than a flicker fusion frequency of an observer. In particular, synchronizer 28 is configured to generate signals or to otherwise link the changing between states of screen 22, projector 24 and ambient light source 26 such that screen 22, projector 24 and ambient light source 26 change between their states at a frequency of at least 50 hertz.

In the particular example illustrated in FIG. 2, projector 24 and screen 22 are in the second projection state 44 and the second reflective state 54 in which green-colored light is projected and reflected a greater proportion of time as compared to the first projection state 42, the first reflective state 52, the third projection state 46 and the third reflective state 56. As a result, ambient light source 26 provides red-colored light and blue-colored light a greater proportion of time as compared to green-colored light. Because ambient light source 26 provides green-colored light for a smaller percentage of time, image contrast is further enhanced. In other embodiments, the proportion of time at which projector 24, screen 22 and light source 26 are in their respective states may be uniform or may have other relative proportions.

Overall, because screen 22 reflects the same color of light that is concurrently being projected by projector 24, the visible light projected by projector 24 is substantially reflected and received by an observer as an image. At the same time, because ambient light source 26 is providing a color of light that is not reflected by screen 22, such light is absorbed or scattered and is substantially not reflected back to an observer, maintaining contrast of the image reflected to the observer. However, the other colors of light provided by ambient light source 26 illuminate the ambient environment of screen 22. Because ambient light source 26 provides each of red, green and blue colored light at least once every 1/50 second or at a frequency greater than a flicker fusion frequency of an observer, such light provided by ambient light source 26 is perceived as white light by an observer. Because ambient light source 26 provides both green and blue light while projector 24 and screen 22 are projecting or reflecting red light, because ambient light source 26 provides both red and blue light while projector 24 and screen 22 are projecting and reflecting green light and because ambient light source 26 provides both red and green light while projector 24 and screen 22 are projecting and reflecting blue light, the brightness of ambient light provided by ambient light source 26 is enhanced as compared to those embodiments in which ambient light source provides a single color of light at a time. In other embodiments, ambient source 26 may alternatively provide a single color of light during the projection and reflection of a different colored light by projector 24 and screen 22.

FIG. 3 schematically illustrates another example of a synchronization timing sequence 70 that may be implemented by synchronizer 28. As shown by FIG. 3, projector 24 changes between projection states 72, 74, 76 and 78 in response to signals from synchronizer 28 (shown in FIG. 1). During projection state 72, projector 24 (shown in FIG. 1) projects red light components of a projected image. During projection state 74, projector 24 projects green components of light. During projection state 76, projector 24 projects blue components of light. During projection states 78, projector 24 is in an interrupted state in which the projection of light from projector 24 is blocked or otherwise temporarily interrupted. For example, in one embodiment in which projector 24 includes a color wheel, state 78 may occur as a result of dead zones or virtual spokes during which light is not projected from projector 24 between filter segments of the color wheel (not shown). In still other embodiments in which projector 24 includes multi-colored light emitting diodes, projection state 78 may occur when projector 24 is transitioning from one set of colored diodes to another set of colored diodes.

As further shown by FIG. 3, screen 22 changes between screen reflective states 82, 84, 86 and 88 based at least in part upon signals from synchronizer 28. In reflective state 82, screen 22 reflects red light. In reflective state 84, screen 22 reflects green light. In reflective state 86, screen 22 reflects blue light. In reflective states 88, screen 22 is configured to absorb whatever light is being provided by ambient light source 26 during source states 98. According to one embodiment in which ambient light source 26 provides white light (red light, green light and blue light), screen 22 is configured to substantially absorb substantially all colors of visible light in reflective states 88. In one embodiment, screen 22 is substantially black during screen reflective states 88. As shown by FIG. 3, synchronizer 28 operates such that screen 22 is in states 82, 84, 86 and 88 when projector 24 is in projection states 72, 74, 76 and 78, respectively. In the particular embodiment shown, screen 22 changes between states 82, 84, 86 and 88 in a synchronized manner with the changing of projector 24 between states 72, 74, 76 and 78, respectively. In other embodiments, screen 22 and projector 24 may change between their states in an unsynchronized manner.

As further shown by FIG. 3, ambient light source 26 changes between source states 92, 94, 96 and 98 under the control of synchronizer 28. In state 92, ambient light source 26 (shown in FIG. 1) provides green and/or blue light. In state 94, light source 26 provides red and/or blue light. In state 96, light source 26 provides red and/or green light. In state 98, ambient light source 26 provides white light (i.e., red light, green light and blue light). As further shown by FIG. 3, ambient light source 26 is in states 92, 94, 96 and 98 when projector 24 is in states 72, 74, 76 and 78 and when screen 22 is in states 82, 84, 86 and 88, respectively. In one particular embodiment, synchronizer 28 links screen 22, projector 24 and ambient light source 26 such that ambient light source 26 changes between states 92, 94, 96 and 98 in a synchronized manner with respect to the changing of projector 24 between states 72, 74, 76 and 78 and the changing of screen 22 between states 82, 84, 86 and 88, respectively. In other embodiments, synchronizer 28 may alternatively be configured such that the changing of screen between states 82, 84, 86 and 88 is not synchronized with the changing of projector 24 and screen 22 between their respective states.

In the particular example timing sequence 70 illustrated in FIG. 3, the proportion of time at which projector 24 is in states 72, 74 and 76, screen 22 is in states 82, 84 and 86 and source 26 is in states 92, 94 and 96, is substantially uniform or equal. In other embodiments, the proportion of time at which projector 24, screen 22 and light source 26 are in their different states may be varied. For example, in another embodiment, projector 24, screen 22 and light source 26 may be in states 74, 84 and 94, respectively, for a greater proportion of time as compared to the other states.

As with timing sequence 40, the use of timing sequence 70 by projection system 20 results in enhanced image contrast with ambient lighting. Because screen 22 in states 82, 84 and 86 reflects the particular light being projected by projector 24 in states 72, 74 and 76, respectively, at a frequency greater than a flicker fusion frequency of an observer, screen 22 and projector 24 provide an observer with colored images. At the same time, because screen 22 in states 82, 84 and 86 does not reflect substantially any of the colored light provided by ambient light source 26 during corresponding states 92, 94 and 96, such light provided by ambient light source 26 is absorbed or scattered by screen 22 and does not reduce the contrast of the image being reflected from screen 22. However, the light provided by ambient light source 26 during states 92, 94 and 96 illuminates the environment of screen 22. Because ambient light source 26 provides red, green and blue light and cycles through such light at a frequency greater than the flicker fusion frequency of an observer, the ambient lighting provided by ambient light source 26 is perceived as white light. In other embodiments, light source 26 may alternatively provide less than all three of red, green and blue light, wherein the ambient lighting is perceived as being colored.

With the particular timing sequence 70 shown in FIG. 3, image contrast and ambient lighting is further enhanced when projector 24, screen 22 and ambient light source 26 are in states 78, 88 and 98, respectively. In particular, because screen 22 in state 88 is configured to absorb impinging light to a greater extent as compared to states 82, 84 and 86, light from ambient light source 26 is not reflected by screen 22 and does not reduce image contrast. At the same time, ambient light source 26 in states 98 provides white light or all three of colors red, green and blue. Although such light by ambient light source is not reflected by screen 22, such light provided by ambient light source 26 does enhance the brightness of ambient light. The greater level of absorption by screen 22 during state 88 does not impair or reduce the brightness of the image projected by projector 24 since projector 24 is the interrupted state 78.

FIG. 4 schematically illustrates another example of a synchronization timing sequence 100 that may be implemented by synchronizer 28. With the timing sequence 100 shown in FIG. 4, synchronizer 28 synchronizes operation of screen 22 and ambient light source 26. Projector 24 may or may not be synchronized with the color of light being projected by projector 24. In the example shown in FIG. 4, synchronizer 28 is configured such that screen 22 cycles through reflective states 102, 104 and 106 in which red light, green light and blue light are reflected, respectively. Synchronizer 20 is further configured such that ambient light source 26 (shown in FIG. 1) changes between source states 112,114 and 116 in which red light, green light and blue light are provided, respectively. As shown by FIG. 4, synchronizer 20 is configured such that ambient light source 26 is in the red source state 112 while screen 22 is in the green reflective state 104 and the blue reflective state 106. Likewise, ambient light source 26 is in the green source state 114 while screen 22 is in the red reflective state 102 and the blue reflective state 106. Ambient light source 26 is in the blue light source state 116 while screen 22 is in the red reflective state 102 and the green reflective state 104. Although FIG. 4 illustrates the durations of reflective states 102, 104 and 106 to be substantially equal, in other embodiments, the time durations of reflective states 102, 104 and 106 may be unequal. In addition, transition may occur at other than the indicated times and still preserve the effect. For example, during state 102, while blue and green ambient lights would not affect the red reflective screen state, either blue or green could be in transition or both could be off. Of course, consideration for the amount and color of light provided over the course of the sequence 102, 104, 105 will result in a certain quality of white light. Intensity and timing adjustments may further be provided to move the white point of the resulting ambient room lighting.

With the particular timing sequences 40, 70 and 100 illustrated in FIGS. 2-4, ambient light source 26 provides two of three colors (red, green and blue) while projector 24 projects and screen 22 reflects the third of the colors. In those embodiments in which ambient light source 26 includes distinct light emitters, such light emitters are permitted to rest. For example, during states 62, 92 and 102, red emitters are permitted to rest, during states 64, 94 and 104, green emitters are permitted to rest. During states 66, 96 and 106, blue emitters are permitted to rest. As a result, when not in a resting state, such light emitters may be overdriven to emit a greater intensity of light than would otherwise be achievable during the respective on states with exceeding or substantially exceeding an average power rating of the light emitter. As a result, the brightness or intensity of ambient light provided by light source 26 may be greater without the use of higher intensity and generally more expensive light emitters and heat sinks in light source 26.

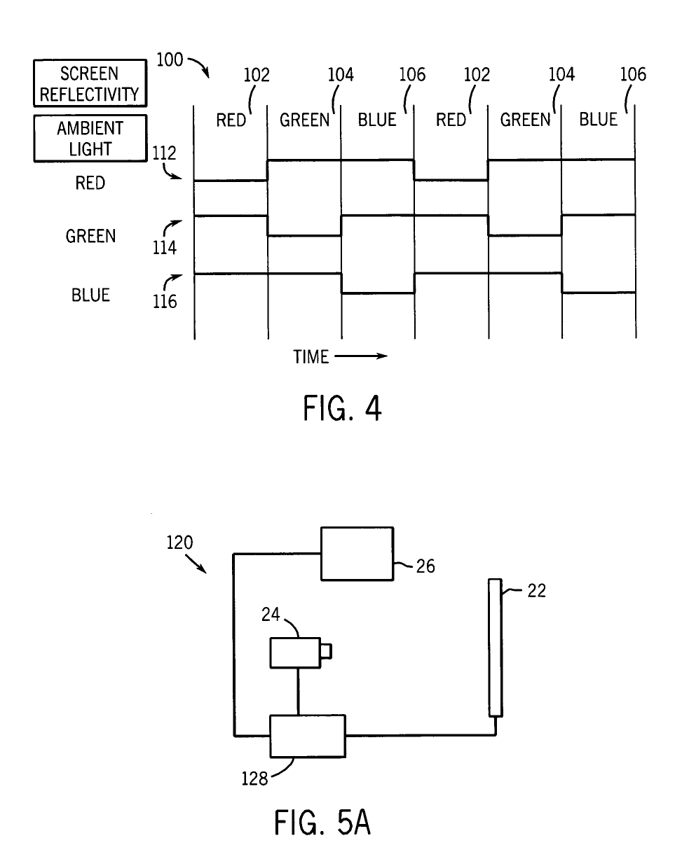

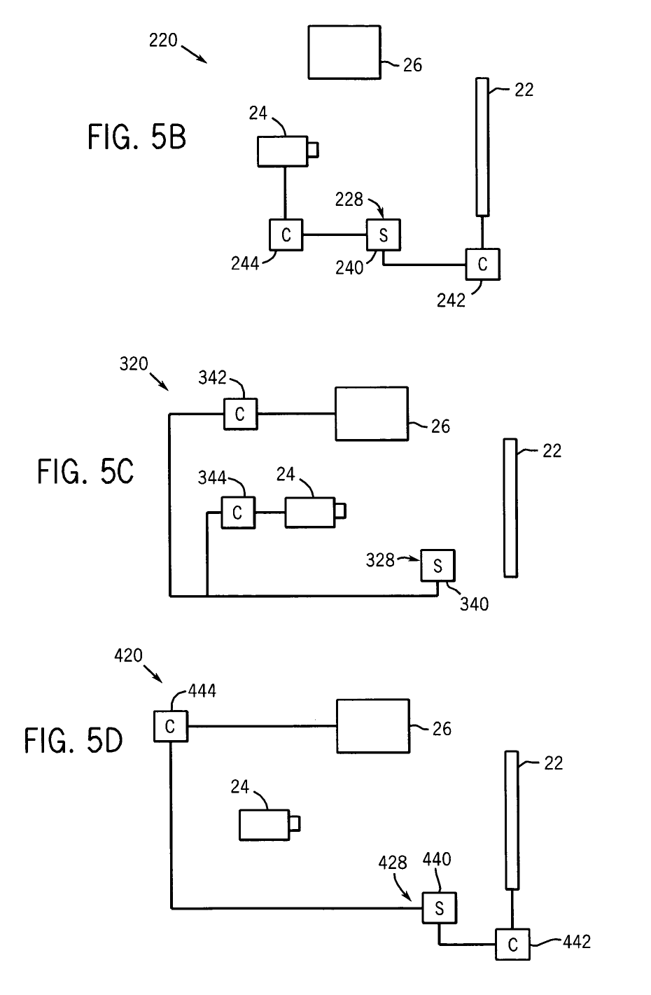

FIG. 5A schematically illustrates projection system 120, a particular embodiment of projection system 20 shown and described with respect to FIGS. 1-3. Projection system 120 is similar to projection system 20 except that projection system 120 has a synchronizer 128 comprising a processing unit configured to generate control signals to both screen 22 and ambient light source 26 so as to synchronize flickering or modulation of screen 22, projector 24 and ambient light source 26 such as according to the timing sequences described in FIGS. 2 and 3. For purposes of this disclosure, the term “processing unit” shall mean a presently developed or future developed processing unit that executes sequences of instructions contained in a memory. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments, hard wired circuitry may be used in place of or in combination with software instructions to implement the functions described. Synchronizer 128 is not limited to any specific combination of hardware circuitry and software, nor to any particular source for the instructions executed by the processing unit.

The processing unit of synchronizer 128 communicates with screen 22 and ambient light source 26, as well as potentially with projector 24, by one of various communication modes such as electrical wire or cabling, optical wire or cabling, infrared or other wireless signals. The processing unit comprising synchronizer 128 may be configured to supply power in a controlled fashion so as to modulate operation of screen 22, projector 24 and ambient light source 26 or may supply electrical or optical signals directing components associated with screen 22, projector 24 and ambient light source 26 to modulate such devices or supply power to such devices in a controlled fashion to cause modulation of such devices. In one embodiment, synchronizer 128 may distribute data or synchronization information over existing electrical wiring such as an alternating current line, wherein screen 22, projector 24 and ambient light source 26 receive the data or synchronization information which serves as a timing and synchronization signal for screen 22, projector 24 and ambient light source 26. In such an embodiment, synchronizer 128 may be physically incorporated into screen 22, projector 24 or ambient light source 26. In other embodiments, synchronizer 128 may synchronize such components in other fashions.

FIG. 5B schematically illustrates projection system 220, another particular embodiment of projection system 20. Projection system 220 is similar to projection system 20 except that projection system 220 includes a synchronizer 228. Those remaining components of projection system 220 which correspond to components of projection system 20 are numbered similarly. In the particular embodiment shown in FIG. 5B, ambient light source 26 is configured to modulate or change between source states and to cycle through such states at a predefined or selected frequency greater than a flicker fusion frequency of a human eye. Synchronizer 228 includes sensor 240, controller 242 and controller 244. In one embodiment, sensor 240 comprises a light sensor configured to sense light emitted or transmitted by ambient light source 26 so as to detect changing of ambient light source 26 between different source states in which different colored light is provided. In one embodiment, sensor 240 comprises a photo sensitive electronic device such as a filtered CdS (Cadmium Sulfide) photoresistor which senses changes in light condition and is off sufficient speed as to adequately sense the light level changes. Other sensor examples include filtered phototransistors and filtered solar cells which have sufficient speed. In other embodiments, sensor 240 may comprise an electrical connection or other sensor directly connected to or associated with ambient light source 26 to detect a characteristic of ambient light source 26 which corresponds to its changing of states. Sensor 240 communicates signals to controller 242 based upon the changing or color of light from ambient light source 26.

Controller 242 comprises a processing unit configured to generate control signals directing the operation of screen 22 and projector 24 based upon signals received from sensor 240. In response to control signals from controller 242, screen 22 changes or modulates between reflectivity states such as states 52, 54, 56 or states 82, 84, 86 and 88. In one embodiment, controller 242 may be physically coupled to sensor 240 as a distinct unit connected to screen 22. In another embodiment, one or both of controller 242 and sensor 240 may be physically incorporated as part of screen 22.

Controller 244 comprises a processing unit configured to generate control signals directing the operation of projector 24 based upon signals from sensor 240. In particular, the operation of projector 24 is synchronized with the operation of screen 22 and the sensed source states of ambient light source 26.

FIG. 5C schematically illustrates projection system 320, another embodiment of projection system 20. Projection system 320 is similar to projection system 20 except that projection system 320 includes synchronizer 328. Those remaining components of projection system 320 which substantially correspond to components of system 20 are numbered similarly. In the example shown in FIG. 5C, screen 22 is configured to change or modulate between reflectance states such as states 52, 54, 56 or states 82, 84 and 86 and to cycle through such states at a predefined or preselected frequency greater than a flicker fusion frequency of the human eye. In one embodiment, screen 22 may include an oscillator and a driver and power supply which facilitate a free running flicker of screen 22. In other embodiments, other electronic circuitry or components may be utilized to facilitate a free running flicker of screen 22 at a frequency greater than a flicker fusion frequency of the human eye.

Synchronizer 328 includes sensor 340, controller 342 and controller 344. Sensor 340 comprises a sensor configured to detect the flickering or modulation of screen 22. In one embodiment, sensor 340 may comprise an optical sensor. According to one exemplary embodiment, sensor 340 may comprise a phototransistor biased to operate with the speed and light reflectance levels of the screen. This photo transistor may be paired with its own light source such as an LED in a configuration that adequately biases and triggers the sensor 340 by the change in reflectivity of the screen. This light source would reduce light interference from other sources including the out-of-sync ambient light source. Another configuration may include the flickering light source in such a way whereby the combination and state of the light source and screen reflectance could generate an error signal which the synchronizer could use to keep the flickering light in sync with the free running frequency of the screen. According to another embodiment, sensor 340 may comprise an electrical or other sensor directly associated with screen 22 to detect a characteristic of screen 22 which corresponds to its flickering. Sensor 340 communicates signals based upon the sensed or detected flickering to controller 342.

Controller 342 comprises a processing unit configured to generate control signals directing the flickering or modulation of ambient light source 26 based upon signals received from sensor 340. In particular, controller 342 generates control signals directing ambient light source 26 to be in states 62, 64 and 66 when screen 22 is in the reflectivity states 52, 54 and 56, respectively. In embodiments where synchronizer 328 operates under timing sequence 70, controller 342 generates control signals directing ambient light source 26 to be in states 92, 94, 96 and 98 when signals from sensor 340 indicate that screen 22 is in states 82, 84, 86 and 88, respectively. In one embodiment, sensor 340 and controller 342 may be incorporated as an independent unit configured to communicate with ambient light source 26. In still another embodiment, sensor 340 and/or controller 342 may alternatively be physically incorporated as part of ambient light source 26. In yet another embodiment, sensor 340 and/or controller 342 may alternatively be physically incorporated as part of a wall switch which controls ambient light source 26.

Controller 344 comprises a processing unit configured to generate control signals directing the operation of projector 24 based upon signals received from sensor 340 or received from source 26. In embodiments where synchronizer 428 operates using timing sequence 40, controller 344 generates control signals directing projector 24 to be in states 42, 44 and 46 when screen 22 is in states 52, 54 and 56 and when source 26 is in states 62, 64 and 66, respectively. In embodiments where synchronizer 328 operates according to timing sequence 70 shown in FIG. 3, controller 344 generates control signals causing projector 24 to be in states 72, 74, 76 and 78 when screen 22 is in states 82, 84, 86 and 88 and when light source 26 is in states 92, 94, 96 and 98, respectively.

FIG. 5D schematically illustrates projection system 420, another embodiment of projection system 20. Projection system 420 is similar to projection system 20 except that projection system 420 includes synchronizer 428. Those remaining components of projection system 420 which substantially correspond to components of system 20 are numbered similarly. In the example shown in FIG. 5D, projector 24 is configured to change or modulate between projection states 42, 44, 46 or states 72, 74, 76 and are cycled through such states at a predefined or preselected frequency greater than a flicker fusion frequency of the human eye.

Synchronizer 428 includes sensor 440, controller 442 and controller 444. Sensor 440 comprises a sensor configured to detect colored light projected by projector 24. In one embodiment, sensor 440 may comprise an optical sensor. According to one embodiment, sensor 440 is incorporated as part of screen 22. In yet another embodiment, sensor 440 may be provided at other locations anywhere along a path of light from projector 24 to screen 22. Based upon the sensed color of light projected by projector 24, sensor 440 generates signals which are communicated to controllers 442 and 444.

Controller 442 comprises a processing unit configured to generate control signals directing the operation of screen 22 based upon signals received from sensor 440. In response to control signals from controller 442, screen 22 changes or modulates between reflective states such as states 52, 54, 56 or states 82, 84, 86 and 88. In one embodiment, controller 442 may be physically coupled to sensor 440 as a distinct unit connected to screen 22. In another embodiment, one or both of controller 442 and sensor 440 may be physically incorporated as part of screen 22.

Controller 444 comprises a processing unit configured to generate control signals directing the operation of ambient light source 26 based upon signals received from sensor 440. In particular, controller 444 generates control signals directing ambient light source 26 to be in states 62, 64 and 66 when screen 22 is in reflective states 52, 54 and 56, respectively. In embodiments where synchronizer 428 operates under timing sequence 70, controller 442 generates control signals directing ambient light source 26 to be in states 92, 94, 96 and 98 when signals from sensor 440 indicate that projector 24 is in states 72, 74, 76 and 78, respectively. In other embodiments, controller 442 may generate control signals based upon signals received from controller 442 rather than based upon signals from sensor 440. In still other embodiments, controller 442 may generate control signals directing screen 22 based upon signals from controller 444 instead of basing such control signals upon input from sensor 440. In still other embodiments, controller 442 and controller 444 may be provided by a single processing unit connected to both screen 22 and ambient light source 26.

In each of the systems schematically shown and described with respect to FIGS. 5A-5D, the various components or elements may communicate with one another through hard wiring, wirelessly or via power lines. Although particular embodiments illustrate systems having multiple controllers, such controllers may be provided by a single processing unit or may be provided by multiple distinct processing units.

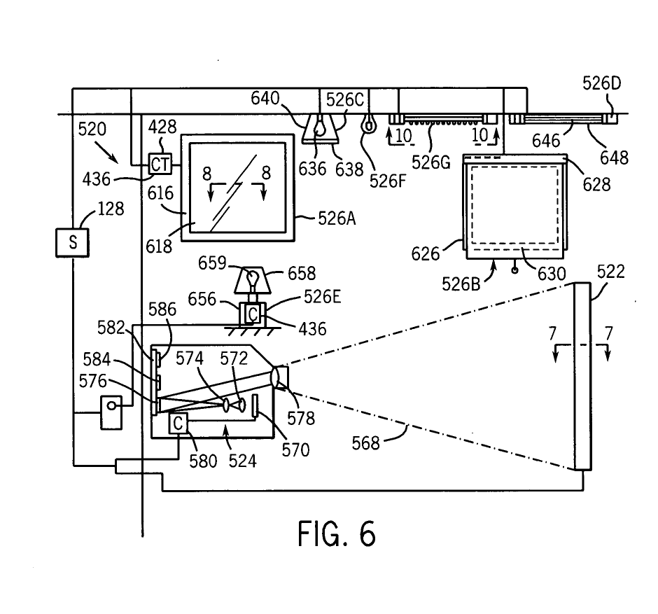

FIG. 6 schematically illustrates projection system 520, one example embodiment of projection system 420. Projection system 520 includes screen 522, projector 524 and ambient light sources 526A, 526B, 526C, 526D, 526E, 526F and 526G, and synchronizer 128. Screen 522 comprises a screen configured to change or modulate between different reflective states in which different colors of light are reflected. In the embodiment illustrated, screen 522 is configured to change between a red reflective state, a green reflective state and a blue reflective state, wherein screen 22 cycles through each of the reflective states at a frequency greater than a flicker fusion frequency of a human eye. In other embodiments, screen 522 is configured to reflect more than one color at a particular time as long as ambient light sources 526A, 526B, 526C, 526D, 526E, 526F and 526G are not providing the same color of light being reflected by screen 22. For example, in such an embodiment, screen 522 may alternatively be configured to reflect red light and green light while ambient light sources 526A, 526B, 526C, 526D, 526E, 526F and 526G provide blue light, wherein projector 524 projects one of red light and green light followed by the other of red light and green light during this same time period.

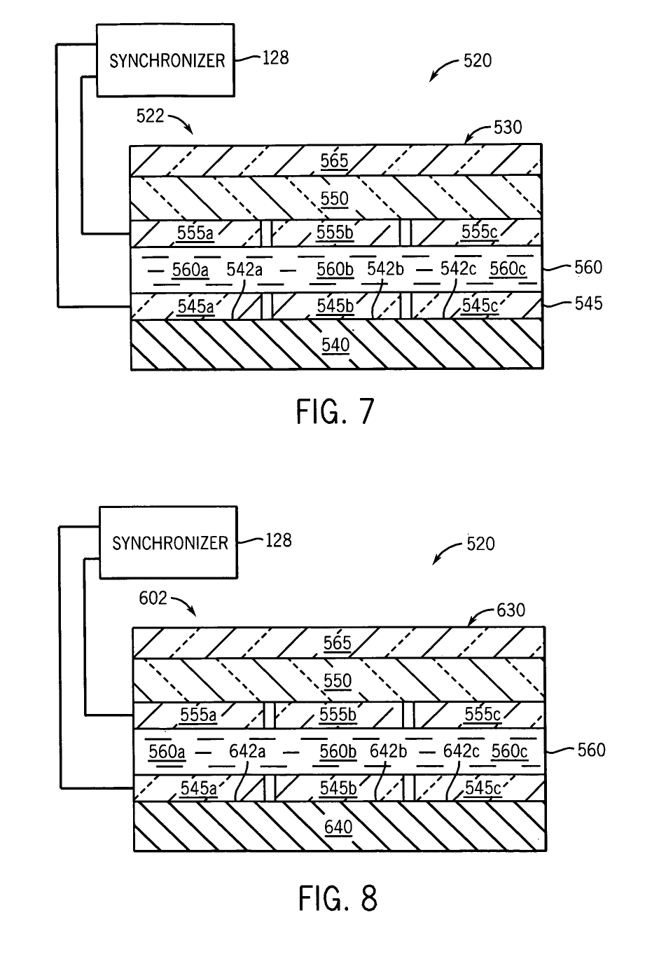

FIG. 7 illustrates an individual pixel 530 of screen 522. In one embodiment, screen 522 includes a plurality of such pixels 530 positioned generally adjacent to one another. Each pixel 530 generally includes back substrate 540, reflective layers 542a, 542b, 542c (collectively referred to as reflective layers 542), electrode layers 545a, 545b, 545c (collectively referred to as electrode layers 545), front substrate 550, electrode layers 555a, 555b and 555c (collectively referred to as electrode layers 555), active layer 560 and coating layers 565. Back substrate 540 serves as a support for reflective layers 542. In one embodiment, back substrate 540 comprises dielectric material such as polyethylene terephthalate (PET) or glass. In other embodiments, back substrate 540 may be formed from other materials.

Reflective layers 542 comprise layers of visible light reflecting material supported by back substrate 540. According to one example embodiment, layers 542 are formed from a transmissive color filter material formed on top of a reflective metallic film such as aluminum. In other embodiments, layer 542 may be formed from other materials such as reflective color patterns. For example, colored dots may be patterned upon substrate 540 by inkjet printing. In still other embodiments, light transmissive color filter materials may be provided adjacent to electrode layers 555, such as between front substrate 550 and electrode layers 555. In another embodiment, reflective layer 542 may alternatively be configured so as to reflect substantially all light without substantially filtering or absorbing light.

Reflective layers 542a, 542b and 542c are configured to reflect distinct colors or wavelengths of visible light such as red, green and blue or such as cyan, magenta and yellow colored light, respectively. In other embodiments, reflective layers 542a, 542b and 542c may comprise distinctly colored filters over a reflective layer. Although reflective layers 542a, 542b and 542c are illustrated as generally located proximate to back substrate 540, reflective layers 542a, 542b and 542c may alternatively be located adjacent to active layer 560 or between active layer 560 and back substrate 540 while still permitting electrode layers 545 to operate as described below. In other embodiments, reflective layers 542a-542c may themselves be electrically conductive, permitting reflective layers 542a, 542b and 542c to be positioned on electrode layers 545a-545c, respectively, adjacent active layer 560.

Electrode layers 545 comprise layers of electrically conductive material configured to be electrically charged so as to apply an electric field across active layer 560. Electrode layers 545a, 545b, 545c are configured to selectively apply distinct voltages across active layer 560 to control the opacity or translucency of adjacent portions of active layer 560. In the particular embodiment illustrated, electrode layers 545a, 545b and 545c are formed from the transparent or translucent electrically conductive materials and overlie reflective layers 542a, 542b and 542c of reflective layer 542. For example, one embodiment, electrode layers 545 may comprise a conductive material such as indium tin oxide (ITO) or polyethylenedioxythiophene (PEDOT). In other embodiments, electrode layers 545a, 545b and 545c may themselves be configured to reflect different colors of light such as red, green and blue or such as cyan, magenta and yellow, enabling reflective layer 542 to be omitted. In other embodiments, electrode layers 545 may be formed from other electrically conductive materials.

Front substrate 550 comprises a support structure for electrode layers 555. Front substrate 550 is formed of an optically transparent and clear dielectric material. In one embodiment, front substrate 550 may be formed from an optically clear and flexible dielectric material such as polyethylene terephthalate (PET). In other embodiments, front substrate 550 may be formed from other transparent dielectric materials that may be inflexible such as glass.

Electrode layers 555 comprise layers of transparent or translucent electrically conductive material formed upon front substrate 550. Electrode layers 555 are configured to be charged so as to cooperate with electrode layers 545 to create an electric field across active layer 560. Electrode layers layers 555a, 555b and 555c configured to be independently charged to distinct voltages to create differing electrical fields across active layer 560. In one embodiment, electrode layers 555 are formed from a transparent conductor such as indium tin oxide (ITO) or polyethylenedioxythiophene (PEDOT). In other embodiments, other transparent conductive materials may be used. Electrode layers 555 and electrode layers 545 are each electrically connected to synchronizer 128 which controls the charges created across electrode layers 545 and 555.

In one embodiment, electrode layers 545a-545c and layers 555a-555c of each pixel 530 are configured to be independently charged. In one embodiment, electrode layers 545a-545c and electrode layers 555a-555c of each of pixels 530 are electrically connected to a voltage source by an active matrix of electrical switching devices provided in electrode layers 545, back substrate 540 or another active back plane. Examples of switching devices may include thin film transistors and metal-insulator-metal devices.

In other embodiments, electrode layers 545a-545c of each pixel 530 may be configured to be independently charged to distinct voltages with the other electrode layers not configured in this fashion. In such an embodiment, electrode layers 555 may alternatively comprise a single continuous layer of electrically conductive material extending opposite to electrode layers 545a-545c. In another embodiment, electrode layers 555a-555c of each pixel 530 may be configured to be independently charged with the other electrode layers not configured in this fashion. In such an embodiment, electrode layers 545a-545c may alternatively be replaced with a single continuous layer of electrically conductive material extending across each of reflective layers 542a-542c.

Active layer 560 comprises a layer of material configured to change its transparency and reflectivity in response to changes in an applied voltage or charge. In one embodiment, active layer 560 may change from a transparent or translucent state, allowing light to pass through active layer 560 and to be reflected from at least one of reflective layers 542a-542c of electrode layers 545, to a generally opaque state in which light is absorbed by active layer 560. According to one example embodiment, active layer 560 may comprise a dichroic dye doped polymer dispersed liquid crystal (PDLC) layer in which pockets of liquid crystal material are dispersed throughout a transparent polymer layer. In other embodiments, active layer 560 may comprise other materials such as electrochromic material, such as tungsten oxide or photochromic or electropheretic material.

Active layer 560 is generally disposed between electrode layers 545 and 555. In one embodiment, active layer 560 is a layer of material continuously extending and captured between electrode layers 545 and 555. For each pixel 530, active layer 560 includes regions 160a, 160b and 160c. Regions 160a-160c generally extend between electrode layers 545a, 555a, electrode layers 545b, 555b and electrode layers 545c, 555c, respectively, and independently respond to voltage changes across the corresponding electrode layers by changing translucency. Regions 160a, 160b and 160c are generally situated across from reflective layers 542a, 542b and 542c, respectively. As a result, the opacity or translucency of regions 160a, 160b and 160c effects how much, if any, incident light may reach and be reflected off of reflective layers 542a, 542b and 542c, respectively.

Coating layer 565 generally comprises one or more layers deposited or otherwise formed on front substrate 550 opposite to electrode layers 555. Coating layer 565 may comprise a front plane diffuser and may include an anti-reflection layer such as anti-glare surface treatment, an ambient rejection layer, such as a plurality of optical band pass filters such as those commercially available from 3M, or a series of micro lenses and/or partial diffuse layers. In other embodiments, coating layer 565 may be omitted.

In operation, synchronizer 128 (described above with respect to FIG. 5A) supplies alternating electrical charge to one or more of electrode layers 545 and 555 to vary the electrical field across electrode layers 545 and 555 so as to also control light transmission or attenuation by regions 560a, 560b and 560c so as to control the color of light reflected from the individual pixel 530 of screen 522. By controlling the color of light reflected from each pixel 530, synchronizer 528 also controls the overall color of light reflected by the total area of screen 522. For example, in one embodiment in which reflective layers 542a, 542b and 542c reflect red, green and blue light, respectively, synchronizer 428 may cause each pixel 530 of screen 522 to reflect red light by creating an alternating electrical field across region 560a such that light is transmitted through region 560a of layer 560 and is reflected off of layer 542a while a lesser electric field or no electric field is applied across regions 560b and 560c such that regions 560b and 560c attenuate transmission of light and such that light is not reflected from reflective layers 545b and 545c. In a similar manner, synchronizer 428 may control charge applied to each of electrode layers 545 and each of electrode layers 555 to control the alternating electric field formed across regions 560b and 560c to also cause each pixel 530 to alternatively reflect green light using reflective layer 542b or blue light using reflective layer 542c. In particular instances where screen 522 is to not reflect light, such as when screen 522 is to be in state 88 (shown in FIG. 3), synchronizer 128 may control supply of alternating charge such that an alternating electric field is not created across regions 560a, 560b or region 560c. As a result, active layer 560 of each of pixels 530 will absorb or scatter light and substantially prevents such light from being reflected off of reflective layers 542.

As shown by FIG. 6, projector 524 comprises a device configured to sequentially project a series of colors (light of different wavelengths) towards screen 522 so as to create an image upon screen 522. In the particular example illustrated, projector 524 comprises a digital light processing (DLP) projector which generally includes light source 570, optics 572, optics 574, digital micro mirror device (DMD) 576 and projection lens 578. Light source 570 comprises a multi-colored (or broad spectrum) solid state lamp configured to sequentially emit different colored light. In one embodiment, light source 570 comprises a multi-colored light emitting diode lamp including multiple differently colored light emitting diodes. In one embodiment, light source 570 includes diodes having red, green and blue colors. In another embodiment, light source 570 may include light emitting diodes having red, green and blue colored light emitting diodes plus possibly white light emitting diodes. The differently colored light emitting diodes are sequentially actuated in response to control signals or applied voltages from controller 580 which comprises a processing unit and a power switching device to selectively direct power to each of the sets of differently colored light emitting diodes of light source 570.

Optics 572 are generally positioned between light source 570 so as to condense light from light source 570 towards optics 574. In one embodiment, optics 572 may include a light pipe or integrating rod. Optics 574 comprises one or more lenses or mirrors configured to focus and direct light towards DMD 576. In one embodiment, optics 574 may comprise lenses which focus and direct the light. In another embodiment, optics 574 may additionally include mirrors which re-direct light onto DMD 576.

In one embodiment, DMD 576 comprises a semiconductor chip covered with a multitude of miniscule reflectors or mirrors which may be selectively tilted between “on” positions in which light is redirected towards lens 578 and “off” position in which light is not directed towards lens 578. The mirrors are switched “on” and “off” at a high frequency so as to emit a grayscale image. In particular, a mirror that is switched on more frequently reflects a light gray pixel of light while the mirror that is switched off more frequently reflects a darker gray pixel of light. In this context, “grayscale”, “light gray pixel”, and “darker gray pixel” refers to the intensity of the luminance component of the light and does not limit the hue and chrominance components of the light. The “on” and “off” states of each mirror are coordinated with colored light from light source 570 to project a desired hue of colored light towards lens 578. The human eye blends rapidly alternating flashes to see the intended hue of a particular pixel in the image being created. In the particular example shown, DMD 576 is provided as part of a DLP board 582 which further supports a processor 584 and associated memory 586. Processor 584 and memory 586 are configured to selectively actuate the mirrors of DMD 576. In other embodiments, processor 584 and memory 586 may alternatively be provided by or associated with controller 580.

Because ambient light sources 526 are changing so as to provide ambient colored light different than the color being projected by projector 524, the color contrast and intensity of light projected by projector 524 is not reduced or washed out by light from ambient light sources 526. As a result, less expensive or lower intensity light sources, such as light source 570 may be employed in projector 524. Because projector 524 facilitates the use of generally lower intensity light emitting diodes for light source 570, the cost and complexity of projector 524 is reduced.

Ambient light sources 526 either emit visual light or transmit visual light to the environment of screen 522 and projector 524. Ambient light sources 526A-526E change between distinct source states and cycle through such states, such as states 62, 64 and 66 or states 92, 94, 96 and 98 (shown in FIGS. 2 and 3), at a frequency greater than or equal to a flicker fusion frequency of a human eye. In the particular embodiment illustrated, each of ambient light sources 526A-526E includes a light transmission modulator 602 shown in FIG. 8.

Ambient light sources 526A and 526B selectively permit the transmission of visual light from another source, such as the sun. Ambient light source 526A generally comprises a window including a frame 616 and a pane 618 and light transmission modulator 602. Frame 616 supports pane 618 and may include electrical components of ambient light source 526A.

Pane 618 of FIG. 6 comprises one or more panes or panels of transparent material, such as glass, supported by frame 600.

Light transmission modulator 602 extends across pane 618 so as to selectively block the transmission of light or to allow transmission of light through pane 618. In one embodiment, light transmission modulator 602 (shown in FIG. 8) may be laminated, bonded or otherwise secured to and across pane 618. In another embodiment, light transmission modulator 602 may be supported by frame 616 so as to extend across and generally parallel to pane 618. In yet another embodiment, one or more portions of pane 618 may be omitted where light transmission modulator 602 has sufficient strength and rigidity. For example, in one embodiment, pane 618 may be omitted where one or both of substrates 604 and 608 is formed from a rigid dielectric material such as glass.

Light transmission modulator 602 comprises a series of layers configured to selectively filter wavelengths of light being transmitted by modulator 602. In one embodiment, light transmission modulator 602 selectively filters light such that red light, green light or blue light are transmitted through modulator 602 while transmission of remaining colors of visible light are attenuated. As shown by FIG. 8, light transmission modulator 602 is substantially similar to screen 522 in that modulator 602 is formed from a multitude of adjacent pixels 630 (one of which is shown in FIG. 8). Each pixel 630 is substantially similar to pixels 530 (shown in FIG. 8) except that each pixel 630 includes filter layers 642a, 642b, 642c (collectively referred to filter layers 642) and substrate 640 in lieu of reflective layers 542a, 542b, 542c and substrate 540, respectively.

Those remaining elements of each pixel 630 of modulator 602 which correspond to elements of each pixel 530 of screen 522 are numbered similarly. Substrate 640 comprises a layer of transparent or translucent material serving as a base or foundation upon which filter layers 642 are deposited or otherwise formed. In the particular embodiment illustrated, substrate 640 is further formed from a dielectric material. In one embodiment, substrate 640 may be formed from an optically clear and flexible dielectric material such as polyethylene terephalate (PET). In other embodiments, substrate 640 may be formed from other transparent or translucent dielectric materials that may be inflexible such as glass.

Filter layers 642 comprise layers of one or more materials configured to filter certain wavelengths of visible light. In the embodiment illustrated, filter layer 642a comprises a layer of material configured to filter substantially all wavelengths of visible light except for red wavelengths of visible light. Filter layer 642b comprises one or more layers of one or more materials configured to filter substantially all wavelengths of visible light except for green wavelengths of visible light. Filter layer 642c comprises one or more layers of one or more materials configured to filter substantially all wavelengths of visible light except for blue wavelengths of visible light. In one embodiment, filter layers 642 may be formed from printed ink on PET. In other embodiments, filter layers 642 may be formed from other materials.

In operation, synchronizer 128 supplies alternating electrical current or charge as appropriate to one or more of electrode layers 545 and 555, individually, of each pixel 630 so as to selectively create electrical fields across individual regions 560a, 560b and 560c of active layer 560 to control the degree of light transmission or light attenuation by such regions 560a, 560b and 560c. By controlling which of regions 560a, 560b and 560c attenuate light versus which of such regions transmit light, synchronizer 128 also controls the resulting color of light emitted from each pixel 630. In such a manner, synchronizer 428 may change pixel 630 of modulator 602 so as to change a light source between different source states in which different colors of light, such as red, green and blue light, are provided.

For example, in one scenario, synchronizer 128 may cause an electrical field to be formed across region 560b by applying an alternating charge to one or both of conductive layers 545b and 555b. At the same time, little or no electrical field is formed across regions 560a and 560b. As a result, region 560 will transmit light while regions 560a and 560c will substantially attenuate the transmission of light. Consequently, light passing through substrate 640, filter layer 642b, region 560b of active layer 560, electrical layer 555b, substrate 550 and layer 565 will be emitted as green light. Regions 560a and 560c will block or attenuate transmission of light before or after passing through filter layers 642a and 642c. Thus, modulator 602 will filter substantially all light from a light emitter except for green light. By similarly controlling each of pixels 630 of modulator 602, synchronizer 428 may actuate modulator 602 to a green filter state. In a similar manner, synchronizer 428 may supply electrical charge to conductive layers 545 and 555 to actuate pixel 630 of modulator 602 to other filter states in which substantially all wavelengths of visible light except for red light or alternatively except for blue light are filtered. In other embodiments, modulator 602 may alternatively be in filter states in which one color of light is filtered out. For example, an electrical field may be created across more than one of regions 560a, 560b and 560c such that more than one of red, green and blue colored light is transmitted through modulator 602.

Ambient light source 526B includes window 626 and window shade 628. Window 626 comprises an opening through which light may pass to the environment of screen 522. In one embodiment, window 526 may include one or more transparent panes through which light may pass. In another embodiment, window 626 may include openings or at least partially transparent screens through which light may pass.

Window shade 628 comprises a device having a selectively transparent or selectively opaque window overlying portion 630. Portion 630 includes light transmission modulator 602 shown and described with respect to FIG. 8. In response to electric fields selectively applied across regions 560a, 560b and 560c of active layer 560, portion 630 modulates or changes between different source states in which light source 526B provides different colors of light such as red, green and blue light. In one embodiment, portion 630 also changes between the aforementioned colored states and a substantially clear or transparent state such as when ambient light source 526B is to be in state 98 (shown and described with respect to timing sequence 70 of FIG. 3).

In the embodiment shown in FIG. 6, portion 630 and light transmission modulator 602 (shown in FIG. 8) are sufficiently flexible so as to permit portion 630 to be rolled up into a roll about an axis. In such an embodiment, substrates 540 and 550 may be formed from a flexible polymeric material such as PET or vinyl, conductive layers 545 and 555 may be formed from a flexible transparent electrically conductive material such as indium tin oxide and active layer 560 may be formed from and may comprise a material such as PDLC material.

Because portion 630 is flexible such that portion 630 may be rolled into a roll, shade 628 may comprise a pull-down shade which may be rolled up so as to extend across window 626 by different extents or so as to be completely retracted with respect to window 626. In other embodiments, shade 628 may comprise other configurations of shades or blinds having a portion 630 that overlies window 626 and includes light transmission modulator 602. For example, shade 628 may alternatively comprise a vertical blind, an accordion-style blind and the like.

Ambient light source 526C emits differently colored light and cycles through such colors at a frequency greater than a flicker fusion frequency of a human eye. Ambient light source 526C includes continuous light emitter 636 and cover 638. Continuous light emitter 636 comprises a source of continuous light such as an incandescent or fluorescent bulb. Light emitter 636 may be recessed within a wall or ceiling or may be partially enclosed by a housing 640.

Cover 638 extends between light emitter 636 and screen 522. Cover 638 is formed from one or more layers of transparent material and additionally includes light transmission modulator 602 (shown in FIG. 8) extending substantially across cover 638. In one embodiment, cover 638 may be substantially provided by light transmission modulator 602. In operation, light transmission modulator 602 changes or cycles through different filter states in which different colors of light are filtered and cycles through such states at a frequency greater than the flicker fusion frequency of a human eye.

Ambient light source 526D emits differently colored light and cycles through such colors at a frequency greater than or equal to the flicker fusion frequency of a human eye. Ambient light source 526D includes continuous light emitter 646 and cover 648. Light emitter 646 generally comprises an elongate tube configured to continuously emit light. In one embodiment, light emitter 646 comprises a gas discharge light cell such as a fluorescent lighting tube.

Cover 648 comprises an elongate cylinder, tube or sleeve extending and positioned about lighting emitter 646. Cover 648 includes light transmission modulator 602 extending between emitter 646 and screen 522. In one embodiment, light transmission modulator 602 extends along a lower portion of cover 648 opposite a lower portion, such as the lower half, of light emitter 646.

In other embodiments, light transmission modulator 602 substantially extends about cover 648 and around or about light emitter 646. In one particular embodiment, cover 648 is removably positioned about light emitter 646, allowing light emitter 646 to be replaced without discarding cover 648. In another embodiment, cover 648 may be mounted to light emitter 646 or light transmission modulator 602 may be coated upon the tube of light emitter 646.

FIG. 9 is a sectional view schematically illustrating ambient light source 526D′, another embodiment of ambient light source 526D. Ambient light source 526D′ includes housing 652, continuous light emitter 654, cover 656, rotary actuator 658 and controller 660. Housing 652 comprises a structure configured to support and at least partially enclose the remaining components of ambient light source 526D′. Housing 652 includes an opening 662 through which a portion of light emitted from emitter 654 passes. Opening 662 is configured such that less than all of filter 664 extend across opening 662 such that light from emitter 654 and exiting through opening 662 is filtered by less than all of filters 664. In other embodiments, the size of opening 662 may be varied. Housing 652 is configured to substantially attenuate the transmission of light not passing through opening 662.

Light emitter 654 comprises an elongate tube configured to continuously emit light. In one embodiment, emitter 654 may comprise a gas discharge light cell such as a fluorescent lighting tube. In other embodiments, emitter 654 may alternatively comprise other elongate light emitting devices such as one or more elongate rows or arrays of light emitting diodes. Emitter 654 is stationarily supported by housing 652 substantially within cover 656.

Cover 656 comprises an elongate cylinder, tube or sleeve extending and positioned about emitter 654. Cover 656 is rotatably coupled or supported by housing 652 so as to rotate about emitter 654. Although a portion of cover 656 is illustrated as protruding from housing 652, in other embodiments, cover 656 may be completely recessed within housing 652. Cover 656 includes filters 664a, 664b and 664c (collectively referred to as filters 664). Filters 664 are each configured to filter a predetermined portion of the visible spectrum of electromagnetic radiation while permitting another portion of the visible spectrum of electromagnetic radiation emitted by emitter 654 to pass therethrough. In the particular example illustrated, filter 664a is configured to substantially filter out or attenuate wavelengths of visible light other than red wavelengths. Filter 664b is configured to substantially attenuate wavelengths of visible light but for green wavelengths. Filter 664c is configured to substantially attenuate wavelengths of visible light but for blue wavelengths. In one embodiment, filters 664a, 664b and 664c may be formed from dichotic materials. In other embodiments, filter 664 may be formed from other materials. Filters 664 cooperate with one another to encircle emitter 654. Although cover 656 is illustrated as including three filters 664, in other embodiments, cover 656 may alternatively include a greater number of filters. For example, in another embodiment, cover 656 may alternatively include a first red filter, a first green filter, a first blue filter, a second red filter, a second green filter and a second blue filter. In yet other embodiments, filter 656 may additionally include a transparent or translucent portion for enabling light source 526D′ to be actuated to state 98 when the timing sequence 70 shown in FIG. 3 is employed.

Rotary actuator 658 (schematically shown) comprises a device configured to rotate cover 656 about emitter 654. In one embodiment, rotary actuator 658 may comprise a motor operably coupled to cover 656 by a gear train, chain and sprocket arrangement, belt and pulley arrangement and the like. In other embodiments, other forms of rotary actuators may be employed.

Controller 660 (schematically shown) comprises a processing unit in communication with rotary actuator 658 and configured to generate control signals directing rotary actuator 658 to rotate cover 656. In one embodiment, controller 660 generates control signals directing rotary actuator 658 to rotate cover 656 to successfully position filters 664a, 664b and 664c across opening 662 so as to cycle through each of filters 664 at a frequency greater than a flicker fusion frequency of a human eye (nominally 50 hertz). In the embodiment shown, controller 660 further generates control signals, based in part upon signals from synchronizer 128 (shown in FIG. 6), directing rotary actuator 658 to rotate cover 656 such that the color filter 664 corresponding to the color of light currently being reflected by screen 522 and being projected by projector 524 is substantially within housing 652. For example, when screen 522 is reflecting red light, filter 664a is substantially within housing 652 while one or both of filters 664b and 664c extend across opening 662 such that light exiting housing 652 from emitter 654 passes through filter 664b and 664c. In the example shown, controller 660 generates control signals based at least in part upon signals or information received from synchronizer 428. In other embodiments, controller 660 may be omitted where rotary actuator 658 receives signals directly from synchronizer 128 (shown in FIG. 6).

In the particular example shown, filters 664 are illustrated as being rotated about emitter 654 so as to change between different filter states such that light source 526D′ also changes between different source states in which different colors of light are provided. In other embodiments, filters 664 may have other configurations and may be selectively positioned in front of a continuous light emitter, such as light emitter 654, in other fashions.

Ambient light source 526E is configured to provide distinct colors of light and to cycle through all of the colors of light, such as red, green and blue, at a frequency greater than or equal to the flicker fusion frequency of a human eye. Ambient light source 526E generally comprises a lamp 656 and a lamp shade 658. Lamp 656 comprises a source of continuous light. For example, in one embodiment, lamp 656 may include an incandescent light bulb or a fluorescent bulb.

Lamp shade 658 is supported about the light bulb of lamp 656 and includes light transmission modulator 602 shown in FIG. 8. Light transmission modulator 602 extends between bulb 659 and screen 522. In one embodiment, light transmission modulator 602 extends along a portion of shade 658. In another embodiment, light transmission modulator 602 extends along a substantial entirety of shade 658 around bulb 659. In response to distinct alternating electrical fields selectively applied across portions of active layer 560, light transmission modulator 602 modulates or changes between different filter states in which modulator 602 selectively filters colors of light such that light source 526E changes between different source states in which selected colors of light are not provided while other colors of light are provided. In particular, modulator 602 changes between different filter states such that light source 526E may operate with respect to projector 524 and screen 522 according to one of the example timing sequences shown in FIGS. 2, 3 and 4.

Ambient light source 526F comprises a device configured to provide distinct colors of light, such as red, green and blue, and to cycle through such colors of light at a frequency greater than or equal to a flicker fusion frequency of a human eye. Ambient light source 526F may comprise a solid state light emitting device such as a light emitting diode light bulb having an arrangement of light emitting diodes configured to sequentially emit different colors of light and a threaded base configured to charge and ground the light emitting diodes. Examples of such light emitting diode bulbs are those commercially available from Enlux Lighting of Mesa, Ariz., and those available from Ledtronics, Inc., of Torrance, Calif. However, unlike such light emitting diode bulbs as those commercially available, ambient light source 526F is configured to cycle through multiple distinct colors, such as red, green and blue, at a frequency greater than the flicker fusion frequency of a human eye. As a result, ambient light source 526 may be synchronized with changing of screen 522 to enhance contrast in the presence of ambient light.

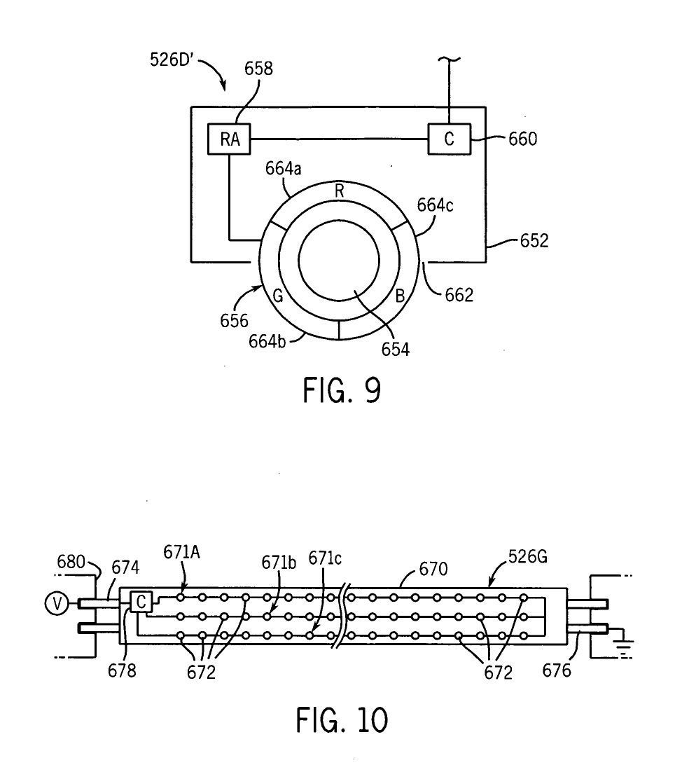

Ambient light source 526G comprises a device configured to change between different filter states in which modulator 602 selectively filters colors of light such that light source 526E changes between different source states in which selected colors of light are not provided while other colors of light are provided. In particular, modulator 602 changes between different filter states such that light source 526E may operate with respect to projector 524 and screen 522 according to one of the example timing sequences shown in FIGS. 2 and 3 at a frequency greater than or equal to the flicker fusion frequency of a human eye. Ambient light source 526G is shown in detail in FIG. 10.

As shown in FIG. 10, ambient light source 526G comprises an elongate support structure 670, rows 671a, 671b and 671c of light emitting diodes 672, axially extending conducting pins 674, 676 and controller 678. Light emitting diodes 672 of row 671a are configured to emit red light. Light emitting diodes 672 of row 671b are configured to emit green light. Diode 672 of row 671c are configured to emit blue light.

Support 670 supports light emitting diodes 672 which are electrically connected to conductive pins 674 and 676. Pin 674 is configured to be connected to a voltage source while pin 676 is configured to be electrically connected to ground. Support 670 and pins 674, 676 are specifically configured to mount within an existing socket 680 for a fluorescent tube or lamp. As a result, the fluorescent tube or lamp may be replaced with ambient light source 526G.

Controller 678 comprises a processing unit configured to generate control signals for selectively powering diodes 672 based at least in part upon signals received from synchronizer 128 (shown in FIG. 6). In particular, controller 678 generates control signals such that ambient light source 526G changes between different source states in which red light, as provided by diodes 672 of row 671a, green light, as provided by diodes light emitting 672 of row 671b and blue light, as provided by light emitting diodes 672 of 671c, is provided and wherein light source 526G cycles through all three colors at a frequency greater than the flicker fusion frequency of a human eye.

According to one embodiment, controller 678 generates control signals such that two of rows 671a, 671b and 671c are powered while the one row 671a, 671b, 671c which would otherwise emit a color of light corresponding to the color of light being reflected by screen 522 during the period of time is off. In one embodiment, controller 436 includes a power supply to provide positive DC or pulsing DC to diodes 672. Because ambient light source 526 may be synchronized with changing of screen 522 between different reflectivity states (as shown in FIG. 2 or FIG. 3), contrast in the presence of ambient light is enhanced.

Overall, projection systems 20, 120, 220, 320, 420 and 520 may maintain the contrast of a projected image that is reflected from a screen while providing an observer of the image with ambient lighting. Because screens 22, 522 changes between different reflectivity states so as to reflect the same color of light being projected by projector 24 or 524, substantially all of the light projected by projector 24 or 524 is reflected back to an observer for enhanced image brightness. Because ambient light source 26, 526 is providing one or more colors of light that are not reflected by screen 22, 522 but are absorbed or scattered by screen 22, 522, image contrast is enhanced. At the same time, ambient light source 26, 526 provides enhanced ambient lighting to the environment of screen 522 and projection systems 20, 120, 220, 320, 420 and 520.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. A system comprising:
a screen configured to operate in a first state in which a first set of one or more colors of light are reflected from the screen and to operate in a second state in which a second set of one or more colors of light, different from the first set, are reflected from the screen; and
a light source configured to provide light having a lessened intensity of one or more colors of light corresponding to the first set or the second set

2. The system of claim 1, wherein the screen is configured to change between the first state and the second state and wherein the light source is configured to change between a first source state during which light having a lessened intensity of one or more colors of light corresponding to the first set are provided and a second source state during which light having a lessened intensity of one or more colors of light corresponding the second set are provided,

3. The system of claim 2, wherein the changing of the light source is synchronized with the changing of the screen.

4. The system of claim 2, further comprising a projector, wherein the changing of the light source is synchronized with the changing of the projector between different projection states in which different colors of light are projected.

5. The system of claim 4, wherein the light source, the projector and the screen are configured to communicate with one another, wherein the projector includes a color wheel having color filter segments separated by physical or virtual spokes and wherein the screen is changed so as to be in the next reflective state during interruption by the spokes of projected light

6. The system of claim 2 further comprising a controller configured to generate control signals, wherein the light source and the screen change between states in response to the control signals.

7. The system of claim 1, wherein the light source includes a light emitter configured to emit a color of light in the first set and wherein the light emitter is configured to be overdriven while the screen is in the second state.

8. The system of claim 1, wherein the light source includes one or more filters configured to filter one or more colors of light being reflected by the screen.

9. The system of claim 1, wherein providing a light having a lessened intensity of one or more colors of light includes blanking the one or more colors of light.

10. The system of claim 1, wherein the screen is configured to reflect red colored light in the first state, wherein the screen is configured to reflect green colored light in the second state, wherein the screen is configured to reflect blue colored light in a third state and wherein the light source is configured to provide a lessened intensity of red colored light during the first state, a lessened intensity of green colored light during the second state and a lessened intensity of blue colored light during the third state.

11. The system of claim 1, wherein the screen is configured to cycle through the states at frequency greater than or equal to about a flicker fusion of an observer.

12. The system of claim 1, wherein the screen is configured to cycle through the states at least 50 times per second.

13. A method comprising:
changing a screen between states in which different colors of light are reflected by the screen; and
changing a light source to blank a color of light corresponding to a color of light reflected by the screen.

14. The method of claim 13, wherein the light source is cycled through the source states at a frequency greater than or equal to about a flicker fusion frequency of an observer.

15. The method of claim 13, wherein the light source is cycled through different source states at a frequency of at least about 50 times per second.

16. The method of claim 13, wherein changing of the screen and the light source are synchronized.

17. The method of claim 13 further comprising changing a projector between projection states in which different colors of light are projected.

18. The method of claim 13, wherein the light source includes one or more filters configured to change between a first filter state in which transmission of the first colored light is attenuated, a second filter state in which transmission of the second colored light is attenuated and a third filter state in which the transmission of the third colored light is attenuated and wherein the method includes changing the one or more filters to the first filter state to change the light source to the first source state, changing the one or more filters to the second filter state to change the light source to the second source state and changing the one or more filters to the third filter state to change the light source to the third source state.

19. The method of claim 13 further comprising:
changing the screen between a first reflective state and a second reflective state having a lower reflectivity; and
changing the light source between a first brightness state when the screen operates in the first reflective state and a second brightness state having a greater brightness when the screen operates in the second reflective state.

20. An apparatus comprising:
a screen configured to change between a first screen state in which a first colored light is reflected, a second screen state in which a second colored light is reflected and a third screen state in which a third colored light is reflected; and
a light source configured to change between a first source state in which the first colored light is not projected, a second source state in which the second colored light is not provided when the screen is in the second screen state and a third source state in which the third colored light is not provided when the screen is in the third screen state.
